(19) United States
(12) Patent Application Publication
(10) Pub. No.: US 2026/0133440 A1
(43) Pub. Date: May 14, 2026

(54) THERMO-OPTIC PHASE SHIFTERS

(71) Applicant: GlobalFoundries U.S. Inc., Malta, NY (US)

(72) Inventors: Yusheng Bian, Ballston Lake, NY (US); Oscar Restrepo, Halfmoon, NY (US); Brian McGowan, Waterbury, VT (US)

(21) Appl. No.: 18/945,698

(22) Filed: Nov. 13, 2024

(51) Int. Cl. G02F 1/01; G02B 6/122; G02F 1/21; G02F 1/225; H05B 3/14

(52) U.S. Cl. CPC G02F 1/0147; G02B 6/122; G02F 1/225; H05B 3/148; G02F 1/212

(57) ABSTRACT

Structures for a thermo-optic phase shifter and methods of forming such structures. The structure comprises a waveguide core, a heater, a first plurality of segments positioned between a portion of the waveguide core and the heater, and a second plurality of segments positioned between the portion of the waveguide core and the heater. The first plurality of segments comprise a first material, the second plurality of segments comprise a second material, and the second plurality of segments alternate with the first plurality of segments.

### BACKGROUND

The disclosure relates to photonics chips and, more specifically, to structures for a thermo-optic phase shifter and methods of forming such structures.

Photonic chips are used in many applications and systems including, but not limited to, data-center communication systems and data computation systems. A photonic chip includes a photonic integrated circuit comprised of photonic components, such as modulators, polarizers, and couplers, that are used to manipulate light received from a light source, such as a laser or an optical fiber.

A thermo-optic phase shifter can be used in the photonic integrated circuit to modulate the phase of light propagating in a waveguide core. Heat is generated by a heater and transferred from the heater to a portion of the waveguide core, which is constructed from a material having a refractive index that varies with temperature. The variation in refractive index may be utilized, for example, by a modulator that incorporates the thermo-optic phase shifter. However, heat generated by the heater but not transferred to the waveguide core is wasted. The inability to efficiently transfer heat from the heater to the waveguide core may limit the performance and reliability of a thermo-optic phase shifter.

Improved structures for a thermo-optic phase shifter and methods of forming such structures are needed.

### SUMMARY

In an embodiment of the invention, a structure for a thermo-optic phase shifter is provided. The structure comprises a waveguide core, a heater, a first plurality of segments positioned between a portion of the waveguide core and the heater, and a second plurality of segments positioned between the portion of the waveguide core and the heater. The first plurality of segments comprise a first material, the second plurality of segments comprise a second material, and the second plurality of segments alternate with the first plurality of segments.

In an embodiment of the invention, a method of forming a structure for a thermo-optic phase shifter is provided. The method comprises forming a waveguide core, forming a heater, forming a first plurality of segments positioned between a portion of the waveguide core and the heater, and forming a second plurality of segments positioned between the portion of the waveguide core and the heater. The first plurality of segments comprise a first material, the second plurality of segments comprise a second material, and the second plurality of segments alternate with the first plurality of segments.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a cross-sectional view of a structure at an initial fabrication stage of a processing method in accordance with embodiments of the invention.

FIG. 2 is a cross-sectional view of the structure at a fabrication stage of the processing method subsequent to FIG. 1.

FIG. 3 is a cross-sectional view of the structure at a fabrication stage of the processing method subsequent to FIG. 2.

FIG. 4 is a cross-sectional view of the structure at a fabrication stage of the processing method subsequent to FIG. 3.

FIG. 5 is a cross-sectional view of the structure at a fabrication stage of the processing method subsequent to FIG. 4.

FIG. 6 is a cross-sectional view of a structure in accordance with alternative embodiments of the invention.

FIG. 7 is a cross-sectional view of a structure in accordance with alternative embodiments of the invention.

FIG. 8 is a cross-sectional view of a structure in accordance with alternative embodiments of the invention.

FIG. 9 is a diagrammatic view of a structure in accordance with alternative embodiments of the invention.

### DETAILED DESCRIPTION

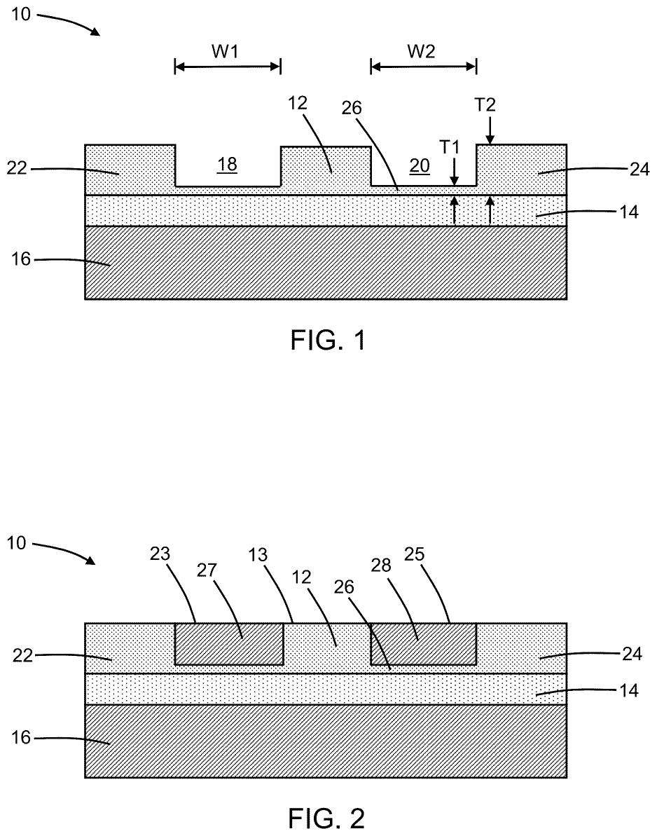

With reference to FIG. 1 and in accordance with embodiments of the invention, a structure 10 for a thermo-optic phase shifter includes a waveguide core 12 that is positioned over a dielectric layer 14 and a substrate 16. In an embodiment, the dielectric layer 14 may be comprised of a dielectric material, such as an oxide of silicon (e.g., silicon dioxide), and the substrate 16 may be comprised of a semiconductor material, such as single-crystal silicon. In an embodiment, the dielectric layer 14 may be a buried oxide layer of a silicon-on-insulator substrate, and the dielectric layer 14 may fully separate the waveguide core 12 from the substrate 16.

The waveguide core 12, which has a top surface 13, may be comprised of a material having a refractive index that varies as a function of temperature. In an embodiment, the waveguide core 12 may be comprised of a material having a refractive index that is greater than the refractive index of silicon dioxide. In an embodiment, the waveguide core 12 may be comprised of a semiconductor material, such as single-crystal silicon, amorphous silicon, or polysilicon.

In an embodiment, the waveguide core 12 may be formed by patterning a layer comprised of the constituent material with lithography and etching processes. In an embodiment, the layer may be patterned by forming an etch mask with a lithography process on the layer, followed by etching unmasked sections of the layer with an etching process. The shape of the etch mask may determine the patterned shape of the waveguide core 12. In an embodiment, the waveguide core 12 may be formed by patterning the semiconductor material (e.g., single-crystal silicon) of the device layer of a silicon-on-insulator substrate. In an embodiment, the waveguide core 12 may be formed by depositing a layer comprised of the constituent material (e.g., amorphous silicon or polysilicon) and patterning the deposited layer.

In an embodiment, the etched layer may include trenches 18, 20 that are positioned adjacent to the waveguide core 12 and ridges 22, 24 adjacent to the trenches 18, 20. The trench 18 is laterally positioned between the waveguide core 12 and the ridge 22, and the trench 20 is laterally positioned between the waveguide core 12 and the ridge 24. In an embodiment, the ridges 22, 24 may extend lengthwise parallel to the length of the waveguide core 12. In an embodiment, the ridges 22, 24 may be symmetrically arranged relative to the waveguide core 12. The trench 18 may have a width dimension W1 measured across the trench 18 from a sidewall of the waveguide core 12 to a facing sidewall of the ridge 22. In an embodiment, the trench 20 may also have the width dimension W2 measured across the trench 20 from a sidewall of the waveguide core 12 to a facing sidewall of the ridge 24.

In an embodiment, a slab layer 26 may be located at the bottom of the trenches 18, 20. The slab layer 26 is formed by partially etching through the layer of material that is patterned to form the waveguide core 12 and trenches 18, 20. The slab layer 26 includes a portion that connects a lower portion of the waveguide core 12 to a lower portion of the ridge 22 and another portion that connects the lower portion of the waveguide core 12 to a lower portion of the ridge 24. The slab layer 26 has a thickness T1, relative to the dielectric layer 14, that is less than the thickness T2 of the waveguide core 12 and the ridges 22, 24. The waveguide core 12 and the slab layer 26 collectively define a rib waveguide. The depth of the trenches 18, 20 is given by the difference between the thickness T2 and the thickness T1.

With reference to FIG. 2 in which like reference numerals refer to like features in FIG. 1 and at a subsequent fabrication stage, a layer 27 is formed inside the trench 18 (FIG. 1), and a layer 28 is formed inside the trench 20 (FIG. 1). In an embodiment, the layers 27, 28 may have respective top surfaces 23, 25 that are coplanar with the top surface 13 of the waveguide core 12. A portion of the waveguide core 12 is positioned in a lateral direction between the layer 27 in the trench 18 and the layer 28 in the trench 20. In an embodiment, the layer 27 may have a width dimension equal to the width dimension W1 of the trench 18, and the layer 28 may have a width dimension equal to the width dimension W2 of the trench 20. Portions of the slab layer 26 are positioned in a vertical direction between the layers 27, 28 and the dielectric layer 14.

The layers 27, 28 are comprised of a material characterized by a given thermal conductivity. In an embodiment, the layers 27, 28 may be comprised of a material characterized by a thermal conductivity that is greater than the thermal conductivity of an oxide of silicon, such as silicon dioxide. In an embodiment, the layers 27, 28 may be comprised of silicon nitride. In an embodiment, the layers 27, 28 may be comprised of aluminum oxide. In an embodiment, the layers 27, 28 may be comprised of diamond. In an embodiment, the material constituting the layers 27, 28 may be deposited and then planarized by chemical-mechanical polishing.

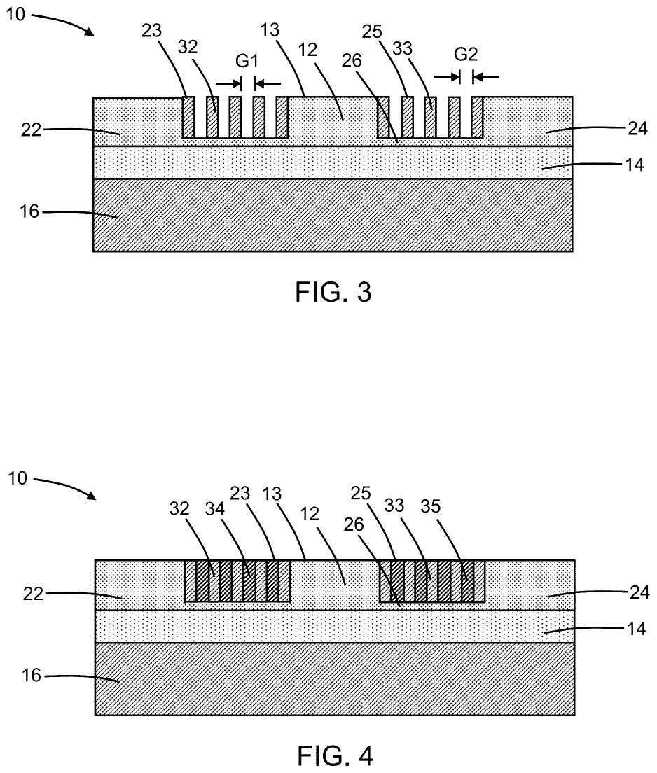

With reference to FIG. 3 in which like reference numerals refer to like features in FIG. 2 and at a subsequent fabrication stage, the layers 27, 28 may be patterned by lithography and etching processes to form segments 32, 33 comprised of the material of the layers 27, 28. The segments 32 are positioned inside the trench 18 (FIG. 1), and the segments 33 are positioned inside the trench 20 (FIG. 1). In an embodiment, the segments 32, 33, which are comprised of the material of the layers 27, 28, retain the top surfaces 23, 25 that may be coplanar with the top surface 13 of the waveguide core 12. The segments 32 are separated by gaps G1 that may extend from the top surface 23 to the slab layer 26, and the segments 33 are separated by gaps G2 that may extend from the top surface 25 to the slab layer 26. In an embodiment, the segments 32 may have a uniform pitch and a uniform duty cycle to define a periodic arrangement, and the segments 33 may have a uniform pitch and a uniform duty cycle to define a periodic arrangement. In alternative embodiments, the segments 32 may have a nonuniform pitch and/or a nonuniform duty cycle to define an aperiodic (i.e., nonperiodic) arrangement, and the segments 33 may have a nonuniform pitch and/or a nonuniform duty cycle to define an aperiodic (i.e., nonperiodic) arrangement.

With reference to FIG. 4 in which like reference numerals refer to like features in FIG. 3 and at a subsequent fabrication stage, the gaps G1 between the segments 32 may be filled by segments 34, and the gaps G2 between the segments 33 may be filled by segments 35. In an embodiment, the segments 34, 35 may have respective top surfaces that are coplanar with the top surfaces 23, 25 of the segments 32, 33 and coplanar with the top surface 13 of the waveguide core 12. The segments 32 alternate in a lateral direction with the segments 34 inside the trench 18 such that their respective materials also laterally alternate, and the segments 33 alternate in a lateral direction with the segments 35 inside the trench 20 such that their respective materials also laterally alternate. A portion of the waveguide core 12 is positioned in a lateral direction between the segments 32, 34 inside the trench 18 and the segments 33, 35 inside the trench 20. The portion of the waveguide core 12 may be laterally spaced from the segments 32, 34 inside the trench 18 and also laterally spaced from the segments 33, 35 inside the trench 20.

The segments 34, 35 are comprised of a different material than the segments 32, 33 such that each of the trenches 18, 20 includes heterogeneous materials that alternate in composition. The segments 34, 35 may be comprised of a material characterized by a thermal conductivity that is greater than the thermal conductivity of the material of the segments 32, 34 and/or a refractive index that is greater than the refractive index of the material of the segments 32, 34. In an embodiment, the segments 34, 35 may be comprised of silicon (e.g., polysilicon). In an embodiment, the material constituting the segments 34, 35 may be deposited and then planarized by chemical-mechanical polishing.

The segments 32, 34 and the segments 33, 35 may be considered to constitute metamaterial structures. Each metamaterial structure can be treated as a homogeneous material having an effective refractive index that is intermediate between the refractive index of the material constituting the segments 32, 33 and the refractive index of the material constituting the segments 34, 35.

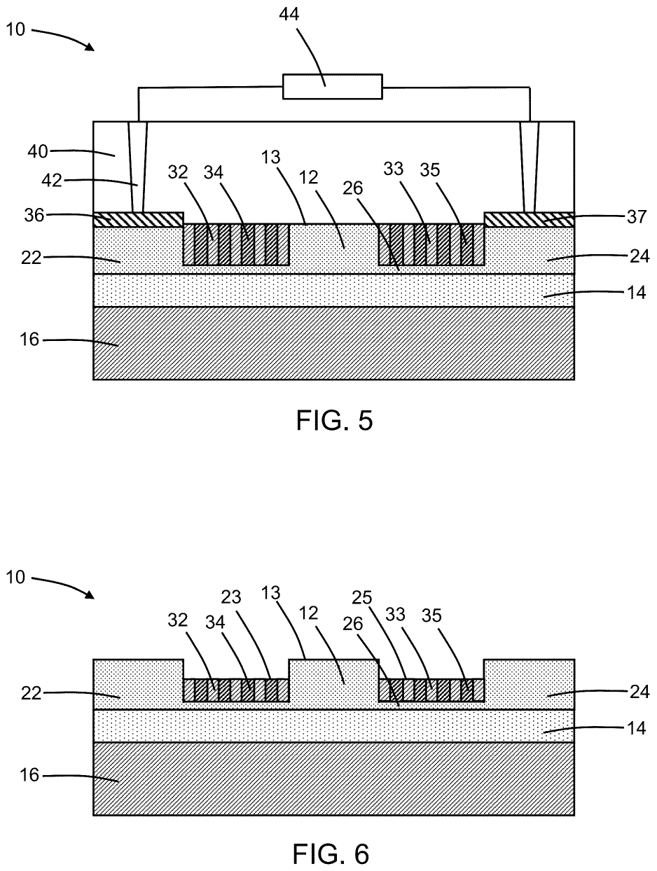

With reference to FIG. 5 in which like reference numerals refer to like features in FIG. 4 and at a subsequent fabrication stage, silicide layers 36, 37 may be respectively formed as stripes on the ridges 22, 24. The silicide layers 36, 37 may be formed by a silicidation process that involves one or more annealing steps to form a silicide phase by reacting the semiconductor material of the ridges 22, 24 with a layer comprised of a silicide-forming metal, such as nickel, that is deposited on the ridges 22, 24. An initial annealing step of the silicidation process may consume all or part of the silicide-forming metal to form the silicide layers 36, 37. Following the initial annealing step, any non-reacted silicide-forming metal may be removed by wet chemical etching. The silicide layers 36, 37 may then be subjected to an additional annealing step at a higher temperature to form a lower-resistance silicide phase. The silicide layer 36 on the ridge 22 may represent a heater of the thermo-optic phase shifter, and the silicide layer 37 on the ridge 22 may represent another heater of the thermo-optic phase shifter.

A dielectric layer 40 is formed over the waveguide core 12, the segments 32, 34 inside the trench 18, the segments 33, 35 inside the trench 20, and the silicide layers 36, 37. The dielectric layer 40 may be comprised of a dielectric material, such as an oxide of silicon (e.g., silicon dioxide), that is deposited and then planarized following deposition. The dielectric material constituting the dielectric layer 40 may have a refractive index that is less than the refractive index of the material constituting the segments 32, 33 and less than the refractive index of the material constituting the segments 34, 35. The segments 32, 33 and the segments 34, 35 are formed and therefore present inside the trenches 18, 20 before depositing the dielectric layer 40. In an embodiment, the material constituting the dielectric layer 40 may have a lower thermal conductivity than the material constituting the segments 32, 33 and the material constituting the segments 34, 35.

Contacts 42 are formed in the dielectric layer 40, and the contacts 42 are physically and electrically connected to the silicide layers 36, 37. The contacts 42 may be comprised of a metal, such as tungsten, that is deposited in openings patterned in the dielectric layer 40. The contacts 42 may connect the silicide layers 36, 37 with a power source 44 that can be operated to supply a current that causes Joule heating of the silicide layers 36, 37 such that the silicide layers 36, 37 can generate heat that is transferred to the waveguide core 12.

In an embodiment, the thermo-optic phase shifter embodied in the structure 10 may be deployed in an arm of a Mach-Zehnder interferometer or in a micro-ring resonator, either with or without a sealed undercut in the substrate 16.

In use, the power source 44 is operated to supply a current that causes Joule heating of the silicide layers 36, 37. Heat generated by the silicide layer 36 is transferred to a portion of the waveguide core 12 through a heat transfer path that includes the segments 32 and the segments 34. Heat generated by the silicide layer 37 is transferred to a portion of the waveguide core 12 through a heat transfer path that includes the segments 33 and the segments 35. The temperature of a portion of the waveguide core 12 is elevated by the transferred heat. A temperature gradient exists across the heat transfer paths with the waveguide core 12 being cooler than the silicide layers 36, 37. The temperature increase experienced by the waveguide core 12 is effective to change the refractive index of the material constituting the waveguide core 12 and to thereby alter the phase of light propagating in the heated portion of the waveguide core 12. The segments 32, 33 and the segments 34, 35 provide patterned cladding for light confinement inside the heated portion of the waveguide core 12.

The segments 32, 33 and the segments 34, 35 may be comprised of a combination of heterogeneous materials that can be selected to optimize both optical performance and thermal performance. In addition to the heat transferred to the waveguide core 12 through the slab layer 26, heat may be transferred from the silicide layer 36 through the composite structure including the segments 32 and the segments 34 to a portion of the waveguide core 12, and heat may be transferred from the silicide layer 37 through the composite structure including the segments 33 and the segments 35 to the same portion of the waveguide core 12. As a result, the segments 32, 33 and the segments 34, 35 increase the efficiency of heat transfer from the silicide layers 36, 37 to the waveguide core 12 during operation of the thermo-optic phase shifter by reducing the temperature gradient. The segments 32, 33 and the segments 34, 35 replace portions of the dielectric layer 40 that would conventionally fill the trenches 18, 20 and that would conventionally be comprised of a material characterized by a lower thermal conductivity.

The higher thermal conductivity of the segments 32, 33 and the segments 34, 35, in comparison with the dielectric layer 40, may improve the reliability of the thermo-optic phase shifter because the operating temperature of the silicide layers 36, 37 can be reduced to provide an equivalent temperature at the waveguide core 12. The reduced operating temperature of the silicide layers 36, 37 may also reduce the power consumption of the thermo-optic phase shifter such that the thermo-optic phase shifter is more energy efficient. Optical confinement may be improved in comparison with thermo-optic phase shifters having a single material, such as an oxide of silicon like silicon dioxide, in the spaces between the waveguide core 12 and the silicide layers 36, 37.

With reference to FIG. 6 and in accordance with alternative embodiments, the segments 32, 33 and the segments 34, 35 may be recessed to have top surfaces 23, 25 that are non-coplanar with the top surface 13 of the waveguide core 12. Instead, the segments 32, 33 and the segments 34, 35 have a recessed height that is less than the depth of the trenches 18, 20 (FIG. 2). The dielectric material of the subsequently-deposited dielectric layer 40 may fill the space inside the trench 18 above the recessed segments 32, 34, and the dielectric material of the subsequently-deposited dielectric layer 40 may fill the space inside the trench 20 above the recessed segments 33, 35.

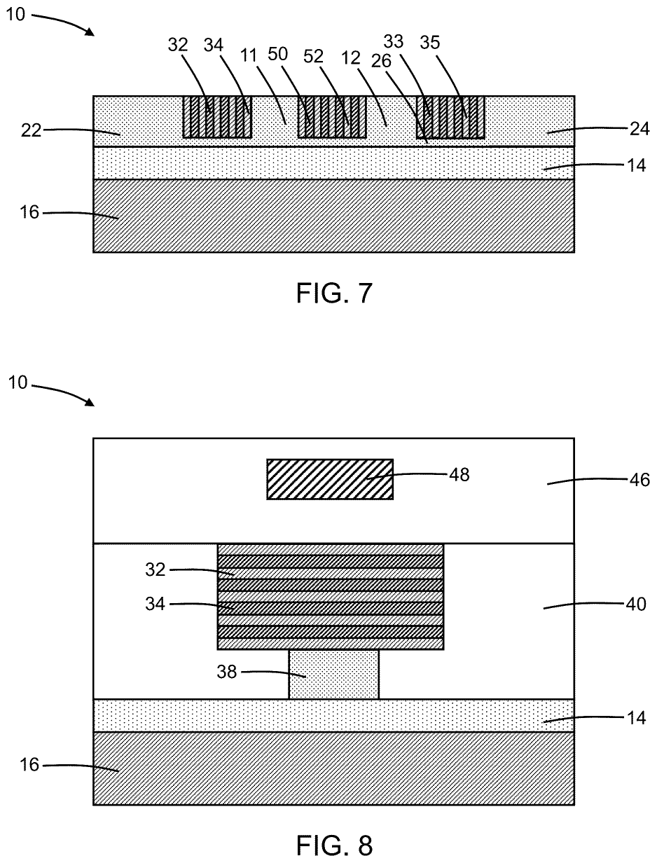

With reference to FIG. 7 and in accordance with alternative embodiments, the structure 10 may include a slotted waveguiding structure in which a waveguide core 11 is positioned adjacent to the waveguide core 12, and alternating segments 50, 52 are positioned as a composite structure of heterogenous materials inside another trench laterally positioned between the waveguide core 11 and the waveguide core 12. The segments 50 may be similar in construction to the segments 32 and the segments 52 may be similar in construction to the segments 34.

With reference to FIG. 8 and in accordance with alternative embodiments, the structure 10 may include a back-end-of-line stack 46 that includes multiple dielectric layers and a heater 48 in one or more of the dielectric layers of the back-end-of-line stack 46. The segments 32 and the segments 34 may be included in a layer stack as a composite structure that is positioned in a vertical direction between the heater 48 and a portion of a waveguide core 38. The segments 32 alternate in a vertical direction with the segments 34. The segments 32, 34 may overlap with the underlying portion of the waveguide core 38, and the heater 48 may overlap with the segments 32, 34. The heater 48 may be comprised of a material such as titanium nitride, nickel silicide, cobalt silicide, polysilicon, tantalum nitride, or another metal or metal alloys. In an embodiment, the waveguide core 38 may be comprised of a semiconductor material, such as single-crystal silicon, amorphous silicon, or polycrystalline silicon. In an alternative embodiment, the waveguide core 38 may be comprised of a dielectric material, such as silicon nitride, silicon oxynitride, or aluminum nitride. In an alternative embodiment, the waveguide core 12 may be comprised of other materials, such as a polymer, thin film lithium niobate, barium titanate or a III-V compound semiconductor.

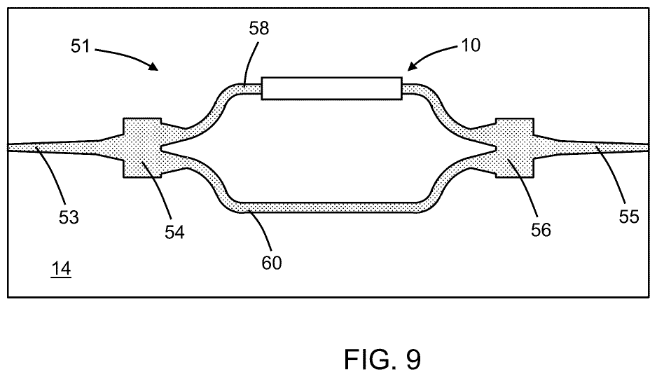

With reference to FIG. 9 and in accordance with alternative embodiments, a Mach-Zehnder interferometer 51 includes an input optical coupler 54, an output optical coupler 56, and waveguide cores 58, 60 defining arms that are separately routed from ports of the input optical coupler 54 to the output optical coupler 56. An input waveguide core 53 is coupled to an input port of the input optical coupler 54, and an output waveguide core 55 coupled to an output port of the output optical coupler 56. In an embodiment, the thermo-optic phase shifter embodied in the structure 10 may be integrated into a portion of the waveguide core 58 representing an arm of the Mach-Zehnder interferometer 51. The thermo-optic phase shifter may be used to generate a phase difference between the light propagating in the waveguide core 58 and light propagating in the waveguide core 60 of the Mach-Zehnder interferometer 51 for generating modulated light at the output port from the output optical coupler 56. In an alternative embodiment, another thermo-optic phase shifter embodied in the structure 10 may also be integrated into the waveguide core 60 representing the other arm of the Mach-Zehnder interferometer 51.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction or plane in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or “directly contacting” another feature if intervening features are absent. A feature may be “indirectly on” or in “indirect contact” with another feature if at least one intervening feature is present. Different features may “overlap” if a feature extends over, and covers a part of, another feature. A feature may “overlie” another feature if a feature is positioned “over” another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for a thermo-optic phase shifter, the structure comprising:
a first waveguide core including a portion;
a first heater;
a first plurality of segments positioned between the portion of the first waveguide core and the first heater, the first plurality of segments comprising a first material; and
a second plurality of segments positioned between the portion of the first waveguide core and the first heater, the second plurality of segments comprising a second material, and the second plurality of segments alternating with the first plurality of segments.

2. The structure of claim 1 wherein the first plurality of segments and the second plurality of segments are laterally positioned between the portion of the first waveguide core and the first heater, and the second plurality of segments alternate in a lateral direction with the first plurality of segments.

3. The structure of claim 1 wherein the first plurality of segments and the second plurality of segments are vertically positioned between the portion of the first waveguide core and the first heater, and the second plurality of segments alternate in a vertical direction with the first plurality of segments.

4. The structure of claim 1 wherein the first material has a first thermal conductivity, and the second material has a second thermal conductivity that is greater than the first thermal conductivity.

5. The structure of claim 1 wherein the first material has a first refractive index, and the second material has a second refractive index that is greater than the first refractive index.

6. The structure of claim 1 wherein the first material and the second material have different refractive indices, and the first material and the second material have different thermal conductivities.

7. The structure of claim 1 further comprising:
a second waveguide core including a portion;
a third plurality of segments positioned between the portion of the first waveguide core and the portion of the second waveguide core, the third plurality of segments comprising the first material; and
a fourth plurality of segments positioned between the portion of the first waveguide core and the portion of the second waveguide core, the fourth plurality of segments comprising the second material, and the fourth plurality of segments alternating with the third plurality of segments.

8. The structure of claim 7 wherein the first waveguide core has a first thickness, and further comprising:
a slab layer that connects the portion of the first waveguide core to the portion of the second waveguide core, the slab layer having a second thickness that is less than the first thickness,
wherein the third plurality of segments and the fourth plurality of segments are positioned on the slab layer.

9. The structure of claim 8 wherein the first heater includes a ridge and a silicide layer on the ridge, the slab layer that connects the portion of the first waveguide core to the ridge, and the first plurality of segments and the second plurality of segments are positioned on the slab layer.

10. The structure of claim 1 further comprising:
a second heater;
a third plurality of segments positioned between the portion of the first waveguide core and the second heater, the third plurality of segments comprising the first material; and
a fourth plurality of segments positioned between the portion of the first waveguide core and the second heater, the fourth plurality of segments comprising the second material, and the fourth plurality of segments alternating with the third plurality of segments.

11. The structure of claim 10 wherein the first heater includes a first ridge and a first silicide layer on the first ridge, the second heater includes a second ridge and a second silicide layer on the second ridge, the first waveguide core has a first thickness, and further comprising:
a slab layer that connects the portion of the first waveguide core to the first ridge and to the second ridge, the slab layer having a second thickness that is less than the first thickness,
wherein the first plurality of segments and the second plurality of segments are positioned on the slab layer, and the third plurality of segments and the fourth plurality of segments are positioned on the slab layer.

12. The structure of claim 1 wherein the first heater includes a ridge and a silicide layer on the ridge.

13. The structure of claim 12 wherein the first waveguide core has a first thickness, and further comprising:
a slab layer that connects the portion of the first waveguide core to the ridge, the slab layer having a second thickness that is less than the first thickness,
wherein the first plurality of segments and the second plurality of segments are positioned on the slab layer.

14. The structure of claim 13 wherein the first plurality of segments and the second plurality of segments have a third thickness equal to a difference between the first thickness and the second thickness.

15. The structure of claim 13 wherein the first plurality of segments and the second plurality of segments have a third thickness less than a difference between the first thickness and the second thickness.

16. The structure of claim 1 wherein the first material and the second material are different materials selected from the group consisting of silicon, silicon nitride, diamond, and aluminum oxide.

17. The structure of claim 1 further comprising:
a third plurality of segments laterally positioned between the portion of the first waveguide core and the first heater, the third plurality of segments comprising a third material, and the third plurality of segments alternating with the first plurality of segments and the second plurality of segments.

18. The structure of claim 17 wherein the first material, the second material, and the third material are different materials selected from the group consisting of silicon, silicon nitride, diamond, and aluminum oxide.

19. The structure of claim 1 wherein the first plurality of segments and the second plurality of segments are positioned in a heat transfer path from the first heater to the portion of the first waveguide core.

20. A method of forming a structure for a thermo-optic phase shifter, the method comprising:
forming a waveguide core;
forming a heater;
forming a first plurality of segments positioned between a portion of the waveguide core and the heater, wherein the first plurality of segments comprise a first material; and
forming a second plurality of segments positioned between the portion of the waveguide core and the heater, wherein the second plurality of segments comprise a second material, and the second plurality of segments alternate with the first plurality of segments.
